(19) United States
(12) Patent Application Publication
(10) Pub. No.: US 2009/0020491 A1
(43) Pub. Date: Jan. 22, 2009

(54) BBQ Grill

(76) Inventor: Kitridge Foster, (US)

Correspondence Address: IAN F. BURNS & ASSOCIATES, 4790 Caughlin Parkway #701, RENO, NV, 89519-0907, US

(21) Appl. No.: 11/778,318

(22) Filed: Jul. 16, 2007

(51) Int. Cl. A47J 37/07; A47J 37/00

(52) U.S. Cl. 211/181.1; 99/450

(57) ABSTRACT

A grill rack adapted to provide substantially vertical suspension and elevated suspension of food over existing barbeque grill cooking rack in accordance with additional aspects of the present invention. The grill rack includes a base, and angled support section and an elevated substantially horizontal grill section. The base is configured to support the grill above a heat source of a barbeque, the base defining a base plane, the base plane being substantially horizontal when positioned on the barbeque. The angled support section is attached to the base and provides a surface extending at an angle from the base plane, whereon food to be cooked on the barbeque may be placed against the surface and supported at an angle to the heat source. The substantially horizontal grill section is supported by the angled support sections above the cooking surfaces associated with a barbeque grill. The angled support section also connects the base to the substantially horizontal grill section.

### CROSS REFERENCE TO RELATED APPLICATIONS

This application is a ______ of U.S. patent application Ser. No. ______, filed on ______.

### AND/OR

This application claims priority to U.S. provisional patent application Ser. No. 60/______, filed ______, the contents of which, is herein incorporated fey reference.

### FIELD OF THE INVENTION

The present invention is generally related to barbeque grill racks. The present invention is also related to cooking utensils. More particularly, the present invention is related to a wire grill rack adapted to provide substantially vertical and elevated suspensions of food over a barbeque heat source.

### BACKGROUND

There are multiple varieties of grills, with most falling into one of two categories: gas-fueled and charcoal. A charcoal grill is typically a hollow, metal hemisphere with three legs and a small metal disc to catch ash, with a lower grate to hold the charcoal and an upper grate to hold the food to be cooked. Weber grills, sold by Weber-Stephen Products Co., are popular and are very common and can generally be found in sixes ranging from 14 inches in diameter and up to a about 24 inches in diameter.

Gas-fueled grills typically use propane (LP) or natural gas (NG) as their fuel source, with gas-flame either cooking food directly or heating grilling elements which in turn radiate the heat necessary to cook food. Gas grills are available in sizes ranging from small, single steak grills up to large, industrial sized restaurant grills which are able to cook enough meat to feed a hundred or more people. Gas grills are designed for either LP or NG, although it's possible to convert a grill from one gas source to another.

A recent trend in gas grills is for the manufacturers to add an infrared radiant burner to the back of the grill enclosure. This radiant burner provides an even heat across the burner and is intended for use with a horizontal rotisserie. A meat item (whole chicken, beef roast, pork loin roast) is placed on a metal skewer that is rotated by an electric motor. Smaller cuts of meat can be grilled in this manner using a round metal basket that slips over the metal skewer.

A problem encountered with preparing food ewer a barbeque grill is managing the amount of heat impinging directly onto the surface of food lying on typical wire grill racks. Because of uncontrollable intensity of heat emanating from the heat source, be it charcoal or gas, food such as a steak or hamburger can become overcooked or burned on one surface. Therefore, it is often desirable to place food so that large surfaces are parallel with radiant or convective heat patterns or at an angle to the source of heat. This reduces the intensity of heat on the large surface. If the food is placed in a vertical position, relative to the force of gravity, then juices, produced by the food tend to roll or drip down the food, thereby moistening and basting the food.

### SUMMARY OF ONE EMBODIMENT OF THE INVENTION

### Advantages of One or More Embodiments of the Present Invention

The various embodiments of the present invention may, but do not necessarily, achieve one or more of the following advantages:

the ability to vertical suspend and/or elevate food over a barbeque grill heat source; and

to provide a grill rack adapted to provide substantially vertical suspension and elevated suspension of food over a barbeque grill beat source.

These and other advantages may be realized by reference to the remaining portions of the specification, claims, and abstract.

### Brief Description of One Embodiment of the Present Invention

In accordance with features of the present invention a grill rack includes a base, and angled support section and an elevated substantially horizontal grill section. The base is configured to support, the grill above a heat source of a barbeque, the base defining a base plane, the base plane being substantially horizontal when positioned on the barbeque. The angled support section is attached to the base and provides a surface extending at an angle from the base plane, whereon food to be cooked on the barbeque may be placed against the surface and supported at an angle to the heat source. The substantially horizontal grill section is supported by the angled support sections above the cooking surfaces associated with a barbeque grill. The angled support section also connects the base to the substantially horizontal grill section.

In accordance with additional features of the present invention, the grill rack can be provided in a circular or rectangular footprint. In a circular footprint a lower ring remised a base section lip that can help contain, food in a substantially vertical, orientation while at rest against suspension rods that form the conical section and also suspend the raised horizontal section. In a substantially rectangular footprint, two angled suspension sections connect two base sections and an elevated, substantially vertical, grill section.

In accordance with more features of the present invention, the angled support section is attached to the base and provides a surface extending at an angle from the base plane, whereon food to be cooked on the barbeque may be placed against the surface and supported at an angle to the heat source. Suspension rods forming the angled support section are configured to support, various foods, such as a rack of ribs or butterfly cut chicken, in an angled or near vertical position. A lip formed by the base section further supports the food and prevents the food from moving away from the conical section. By holding food in a vertical or angled position, most of the food's surface is kept away from the heat source, which allows the food to cook more slowly.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 illustrates a perspective view of a wire grill rack adapted to provide substantially vertical and elevated suspensions of food over a barbeque grill heat source surfaces in accordance with, aspects of the present invention.

FIG. 2 illustrates a side view of a wire grill rack adapted to provide substantially vertical and elevated suspensions of food over existing barbeque grill cooking surfaces in accordance with aspects of the present invention.

FIG. 3 illustrates a top view of a wire grill rack adapted to provide substantially vertical and elevated suspensions of food over existing barbeque grill cooking surfaces in accordance with aspects of the present invention.

FIG. 4 illustrates a perspective view of a wire grill rack suspending food in a substantially vertical manner and also supporting food above normal barbeque grill, cooking surfaces in accordance with aspects of the present invention.

FIG. 5 illustrates a perspective view of a wire grill rack adapted to provide substantially vertical and elevated suspension of food over existing barbeque grill cooking rack in accordance with additional aspects of the present invention.

FIG. 6 illustrates a top view of a wire grill rack adapted to provide substantially vertical, and elevated suspension of food over existing barbeque grill cooking rack in accordance with additional aspects of the present invention.

FIG. 7 illustrates an end view of a grill rack adapted to provide substantially vertical and elevated suspension of food over existing barbeque grill cooking rack in accordance with additional aspects of the present invention.

FIG. 8 illustrates a side view of a wire grill rack adapted to provide substantially vertical and elevated suspension of food over existing barbeque grill cooking rack in accordance with additional aspects of the present invention.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

The present invention comprises a wire grill or rack adapted to support food in a substantially vertical or angled position over a heat source of a barbeque grill as well as providing horizontal suspension of food at a distance over a barbeque heat source. The grill may be used with barbecues from various manufacturers. For example, the present invention may be used with a Webber™ barbecue grill, which is known for its round shape. It should be appreciated that invention could be either supported by a grill surface associated with a barbeque or it could be supported by the structure of the barbeque.

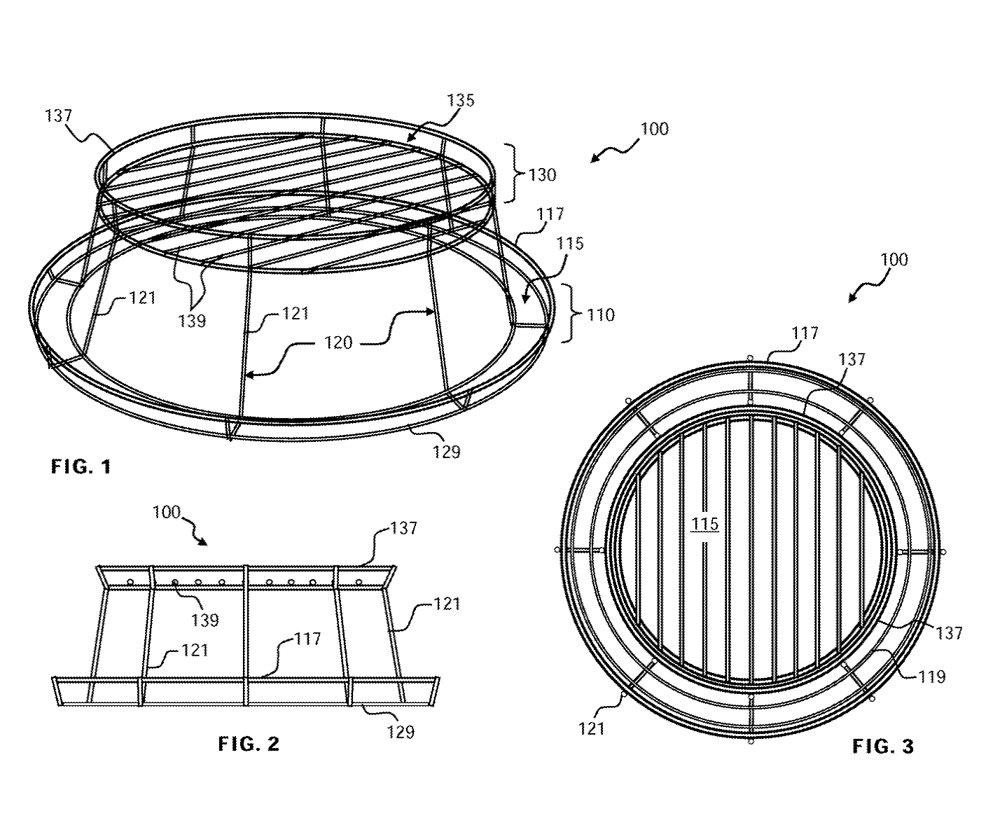

Referring to FIGS. 1-3, the wire grill rack 100 comprises a base section 110, a conical section 120 and a raised horizontal section 130. A lower ring 117 formed a base section lip that can help contain food in a substantially vertical orientation while at rest against suspension rods 121 that form the conical section 120 and also suspend the raised horizontal section 130. The grill can be made from metal wire or rods that are bent appropriately to form the grill rack sections or are cut to form food supporting rods 139 as part of the raised horizontal section 130. The metal wire/rods are welded together to form the grill rack 100. The metal rods and the welds must be capable of withstanding the heat encountered in barbecues. The metal may be steel and it may be chrome plated to provide a more attractive appearance and to resist staining. The base section 110 is configured to rest on top of a horizontal flat grill of the barbecue. Alternatively, base section 110 may be configured to be supported by a structure of a barbecue, such as side wall of the barbecue. Generally, a heat source, such as charcoal or gas, is provided below the horizontal grill.

Suspension rods 121 forming the conical section 120 are configured to support various foods, such as a rack of ribs or butterfly cut chicken, in an angled or near vertical position. The lip 117 further supports the food and prevents the food from moving away from the conical section 120. By holding food in a vertical or angled position, most of the food's surface is kept away from the heat source, which allows the food to cook more slowly. Furthermore, the vertical or angled position, allows hot air to flow over and around the food as opposed to directly over only one surface of the food. The conical section preferably comprises a plurality of rods 121 that extend inwardly at an angle from the base to the horizontal section. The rods 121 are positioned at different radial positions. One or more rings 119 may be attached to the rods 121 to provide additional support to them.

The raised horizontal section 130 is configured to hold a variety of foods, such as vegetables or burgers, further away from the heat source. This allows the food to be cooked more slowly and it allows more hot air to circulate around the food. A source of moisture, such as a can of beer, can also be placed on the horizontal section. The horizontal section can comprise a plurality or rods 139 in a spaced parallel relationship. In another embodiment, the horizontal section can comprise a plurality of rods in a perpendicular orientation. A second ring 137 forming another lip can be provided for enabling the retentions of food on and within the cooking areas 135 of the horizontal section.

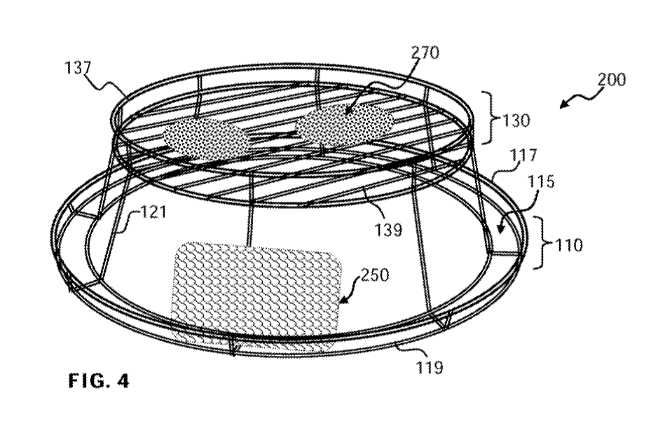

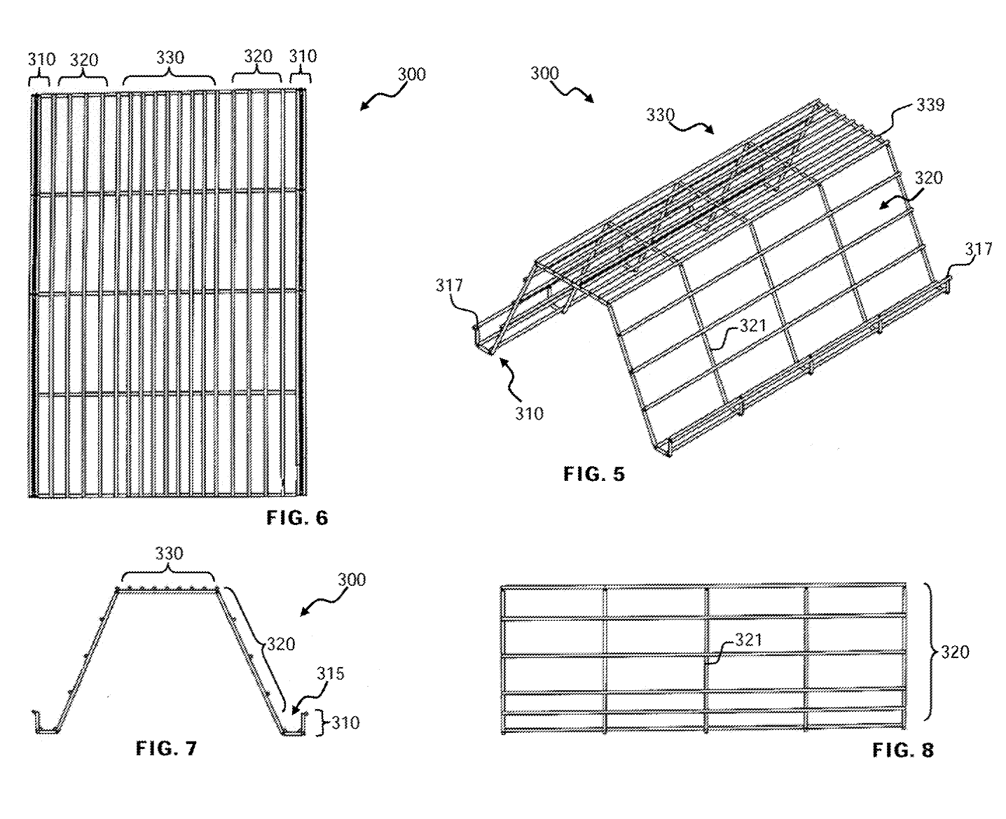

Referring to FIGS. 4-8, illustrated is a perspective view of a wire grill rack 300 adapted to provide substantially vertical 320 and elevated, horizontal 330 suspension of food over existing barbeque grill cooking rack in accordance with additional aspects of the present invention. Rather than a circular design, the embodiment shown in FIGS. 4-8 provides a substantially rectangular footprint for the invention. As with the circular version of the invention, the rectangular design continues to have the three main functional components of the present invention: a base section 310, a substantially vertical mid-section 320 and an elevated, horizontal section 330. The base section 310 has a lip 317 for helping to retain food substantially vertical to a barbeque grills cook top (not shown) together with rods 321 creating a supporting area as part of the substantially vertical mid-section 320. The raised horizontal section 330 also

[symbol]

1-18. (canceled)

19. A grill comprising:
a) a first ring and a second ring connected by a first set of rods to form a base;
b) a third ring connected to the second ring by a second set of rods to define a first retaining section;
c) a fourth ring connected to the first ring by a third set of rods;
d) a fifth ring connected to the fourth ring by a fourth set of rods; and
e) a fifth set of rods connected to the fourth ring, the fifth set of rods and the fifth ring defining a second retaining section.

20. The grill in accordance with claim 19, wherein the third set of rods are angled with respect to the base.

21. The grill in accordance with claim 19, wherein the first retaining section is configured to hold food against the third set of rods.

22. The grill in accordance with claim 19, wherein the grill has a conical shape.

23. The grill in accordance with claim 19, wherein a plurality of voids are located between the rings and the rods.

24. A grill comprising:
a) a base having a first set of rings;
b) a first retaining section having a second set of rings;
c) a plurality of angled support rods connecting the first and second set of rings such that the first retaining section is spaced from the base by the angled support rods;
d) a plurality of horizontal support rods connected across at least one ring of the second set of rings; and
e) a second retaining section having a third ring connected to the base.

25. The grill in accordance with claim 24, wherein the second retaining section is configured to hold food against the angled support rods.

26. The grill in accordance with claim 24, wherein the grill has a conical shape.

27. The grill in accordance with claim 24, wherein a plurality of voids are located between the rings and the rods.

28. A grill comprising:
a) a plurality of spaced apart frames, each of the frames having a mid section, a first and second angled section and a first and second base section, the first angled section connected to a first end of the mid section and the second angled section connected to a second end of the mid section, the first base section connected to the first angled section and the second base section connected to the second angled section;
b) a plurality of parallel rods connected between the spaced apart frames;
c) a first lip connected across the first base section, the first lip and the first base section defining a first retaining section; and
d) a second lip connected across the second base section, the second lip and the second base section defining a second retaining section.

29. The grill in accordance with claim 28, wherein the first retaining section is configured to hold food against the first angled section.

30. The grill in accordance with claim 29, wherein the second retaining section is configured to hold food against the second angled section.

31. The grill in accordance with claim 28, wherein a plurality of voids are located between the frames and the rods.
